(19) United States
(12) Patent Application Publication
(10) Pub. No.: US 2009/0294626 A1
(43) Pub. Date: Dec. 3, 2009

(54) MOUNTING STRUCTURE

(76) Inventors: Naoki ABE, Nishikamo-gun (JP); Takahiro Yamafuji, Nagoya-shi (JP)

Correspondence Address: KENYON & KENYON LLP, 1500 K STREET N.W., SUITE 700, WASHINGTON, DC, 20005, US

(21) Appl. No.: 12/468,947

(22) Filed: May 20, 2009

(30) Foreign Application Priority Data
May 29, 2008 (JP) 2008-141528

(51) Int. Cl. F16M 13/00

(52) U.S. Cl. 248/675; 248/674

(57) ABSTRACT

In an engine room accommodating an engine and a motor, an air cleaner accommodated in a resin case is disposed behind an inverter device, which has an inverter circuit for driving a motor and has a connection portion to which a power cable rising on a rear side of a vehicle is connected, with respect to the vehicle. The air cleaner is mounted in regions different from a front lower region thereof, namely, in a front upper region thereof and a rear lower region thereof to the engine room or a member mounted to the engine room. Thus, in the event of a collision of the vehicle, the power cable can be restrained from being deformed or damaged.

### INCORPORATION BY REFERENCE

The disclosure of Japanese Patent Application No. 2008-141528 filed on May 29, 2008 including the specification, drawings and abstract is incorporated herein by reference in its entirety.

### BACKGROUND OF THE INVENTION

1. Field of the Invention

The invention relates to a mounting structure, and more particularly, to a mounting structure in which a resin component and an inverter device are mounted to an accommodation portion accommodating an electric motor for outputting motive power for running in a vehicle equipped with the electric motor. The inverter device has an inverter for driving the electric motor, and is mounted with an electric power cable that rises upward from a lower space behind the inverter with respect to the vehicle and leads to the inverter.

2. Description of the Related Art

Conventionally, as this kind of mounting structure, there is proposed a mounting structure in which an inverter and an engine air cleaner disposed behind this inverter are mounted to a front engine room for a hybrid vehicle (e.g., see Japanese Patent Application Publication No. 2006-175926 (JP-A-2006-175926)). In this structure, the inverter, whose right side has connected thereto a harness for supplying electric power to an electric air-conditioner, is mounted, and the air cleaner is disposed and mounted behind this inverter.

In the event of a collision of a vehicle that has disposed in an engine room in a front region thereof an inverter device having an inverter for driving a motor for running and has mounted behind the inverter device an electric power cable leading to the inverter, the inverter device is pressed against the electric power cable due to the collision. In some cases, the electric power cable receives an unexpected force and is deformed or damaged. In such a vehicle, with a view to restraining the electric power cable from being deformed or damaged, it is also conceivable to dispose an easily deformable resin instrument behind the inverter device instead of disposing a metal instrument behind the inverter. However, in the case where a front lower region of the instrument is mounted with a mounting bracket, the electric power cable is deformed or damaged by this mounting bracket.

### SUMMARY OF THE INVENTION

The invention provides a mounting structure that restrains an electric power cable leading to an inverter disposed in an accommodation portion accommodating an electric motor in a vehicle from being deformed or damaged.

A first aspect of the invention relates to a mounting structure in which an accommodation portion accommodating an electric motor for outputting motive power for running in a vehicle is mounted with a resin component and an electric cable that has an inverter for driving the electric motor, rises upward from a lower space behind the inverter with respect to the vehicle, and leads to the inverter. With the inverter device mounted to the accommodation portion or a member mounted to the accommodation portion with an inverter mounting bracket, and with the resin component disposed behind the inverter device with respect to the vehicle, the resin component is mounted in at least one of a front upper region thereof, a rear upper region thereof, and a rear lower region thereof to the accommodation portion, the member mounted to the accommodation portion or the inverter device with a component mounting bracket.

In the event of a collision of the vehicle with the inverter device and the resin component thus mounted, the inverter device moves backward due to the collision and is pressed against the electric power cable rising behind the inverter. Then, upon receiving a force, the electric power cable moves backward. At this moment, the resin component behind the inverter device is mounted in a region different from the front lower region thereof to the accommodation portion or the member mounted to the accommodation portion. Therefore, in the front lower region of the resin component, the electric power cable is restrained from receiving a force from a mounting member or the like. As a result, in the event of a collision of the vehicle, the electric power cable leading to the inverter can be restrained from being deformed or damaged. It should be noted herein that “the resin component” can be an on-vehicle instrument required for an internal combustion engine and/or the electric motor that are/is installed in the vehicle and accommodated in the accommodation portion, for example, an air cleaner, a resin tank, or the like accommodated in a resin case. Further, “the inverter device” can be a device having only an inverter for driving an electric motor for outputting motive power for running. “The inverter device” can also be a device having an inverter for driving an electric motor different from the electric motor for outputting motive power for running, an inverter for driving an electric compressor for air-conditioning, or the like in addition to the inverter for driving the electric motor for outputting motive power for running.

In the aforementioned mounting structure according to the invention, the resin component can also be mounted in two of the front upper region thereof, the rear upper region thereof, and the rear lower region thereof to the accommodation portion or the member mounted to the accommodation portion with a first mounting bracket and a second mounting bracket as the component mounting bracket. In this case, the resin component can be formed such that the front upper region thereof extends to a rear upper region of the inverter device, and the front upper region of the resin component can also be mounted to the rear upper region of the inverter device with the first mounting bracket. Thus, the number of components can be reduced in comparison with a mounting structure in which the resin component is mounted in two or more regions thereof to the member mounted to the accommodation portion.

A second aspect of the invention relates to a mounting structure having a secondary battery, an inverter device that has an inverter for driving an electric motor for outputting motive power for running a vehicle in an accommodation portion accommodating the electric motor in the vehicle and is mounted with an electric power cable leading to the inverter from the secondary battery, a resin component disposed behind the inverter device with respect to the vehicle and mounted to the accommodation portion, and a component mounting bracket for mounting the resin component to the accommodation portion, a member mounted to the accommodation portion or the inverter device. A portion of electric power cable is provided between the inverter device and the resin component. The component mounting bracket is not provided between the inverter device and the electric power cable or between the electric power cable and the resin component.

### BRIEF DESCRIPTION OF THE DRAWINGS

The features, advantages, and technical and industrial significance of this invention will be described in the following detailed description of an example embodiment of the invention with reference to the accompanying drawings, in which like numerals denote like elements, and wherein:

FIG. 1 is an illustrative view explaining an external appearance of a hybrid vehicle 20 to which a mounting structure as an embodiment of the invention is applied, and a manner in which instruments required for running are mounted on the vehicle;

FIG. 2 is an illustrative view schematically showing an inverter device 32 and an air cleaner 24 that are disposed in an engine room 21 as viewed from a left side of the vehicle;

FIG. 3 is a view of the inverter device 32 and the air cleaner 24 in FIG. 2 as viewed from a III-III face;

FIG. 4 is a view of the inverter device 32 and the air cleaner 24 in FIG. 2 as viewed from a IV-IV face;

FIG. 5 is an illustrative view schematically showing backward movement of the inverter device 32 and the air cleaner 24 in the event of a collision of the vehicle, as viewed from the left side of the vehicle;

FIG. 6 is an illustrative view schematically showing the inverter device 32 and the air cleaner 24 that are disposed in the engine room 21 according to a modification example of the embodiment of the invention, as viewed from the left side of the vehicle;

FIG. 7 is a view of the inverter device 32 and the air cleaner 24 in FIG. 6 according to the modification example of the embodiment of the invention as viewed from a VII-VII face; and

FIG. 8 is an illustrative view schematically showing the inverter device 32 and the air cleaner 24 that are disposed in the engine room 21 according to the modification example of the embodiment of the invention, as viewed from the left side of the vehicle.

### DETAILED DESCRIPTION OF EMBODIMENT

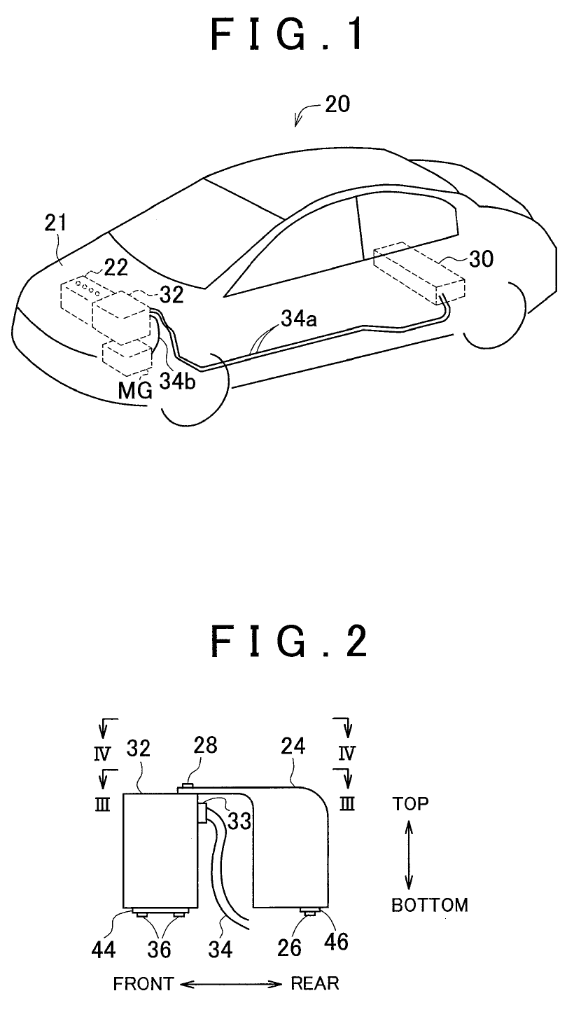

FIG. 1 is an illustrative view for explaining an external appearance of a hybrid vehicle 20 to which a mounting structure as the embodiment of the invention is applied, and a manner in which instruments required for running are mounted on the vehicle. As shown in FIG. 1, an engine 22 that is constructed as an internal combustion engine for outputting motive power through the use of hydrocarbon fuel such as gasoline, light oil, or the like to output motive power to a front wheel side, a motor MG that is constructed as a known synchronous generator motor to output motive power to the front wheel side, and an inverter device 32 having an inverter circuit (not shown) for driving the motor MG are accommodated in an engine room 21 in a front region of the vehicle. Further, a battery 30 as a secondary battery is mounted behind rear seats (not shown) in a rear region of the vehicle. The battery 30 and the inverter circuit of the inverter device 32 are connected to each other by a power cable 34a disposed below the rear seats, and the inverter circuit of the inverter device 32 and the motor MG are connected to each other by a power cable 34b disposed in the engine room 21. Thus, the vehicle can be caused to run with the motor MG driven by electric power from the battery 30 while the engine 22 is intermittently operated. In braking the vehicle, the battery 30 can be charged with electric power from the motor MG The inverter device 32 also has respective inverter circuits for driving a motor (not shown) and an electric compressor (not shown) for air-conditioning. Power cables connected to these respective inverter circuits and the aforementioned power cables 34a and 34b will be referred to comprehensively as a power cable 34.

FIG. 2 schematically shows the inverter device 32 and the air cleaner 24 that are disposed in the engine room 21 as viewed from the left side of the vehicle. The air cleaner 24 is mounted to an intake system of the engine 22 in a state of being accommodated in a resin case that is more easily deformable than instruments and members such as the inverter device 32, the electric power cable 34, and the like, and purifies intake air and supplies to the engine 22 therewith. As shown in FIG. 2, the inverter device 32 has on a rear face thereof a connection portion 33 to which the power cable 34, which rises upward from a lower space behind the inverter device 32, is connected, and the air cleaner 24 is disposed behind the inverter device 32 to which the power cable 34 is thus connected. The mounting structure of the inverter device 32 and the air cleaner 24 that are thus disposed will further be described.

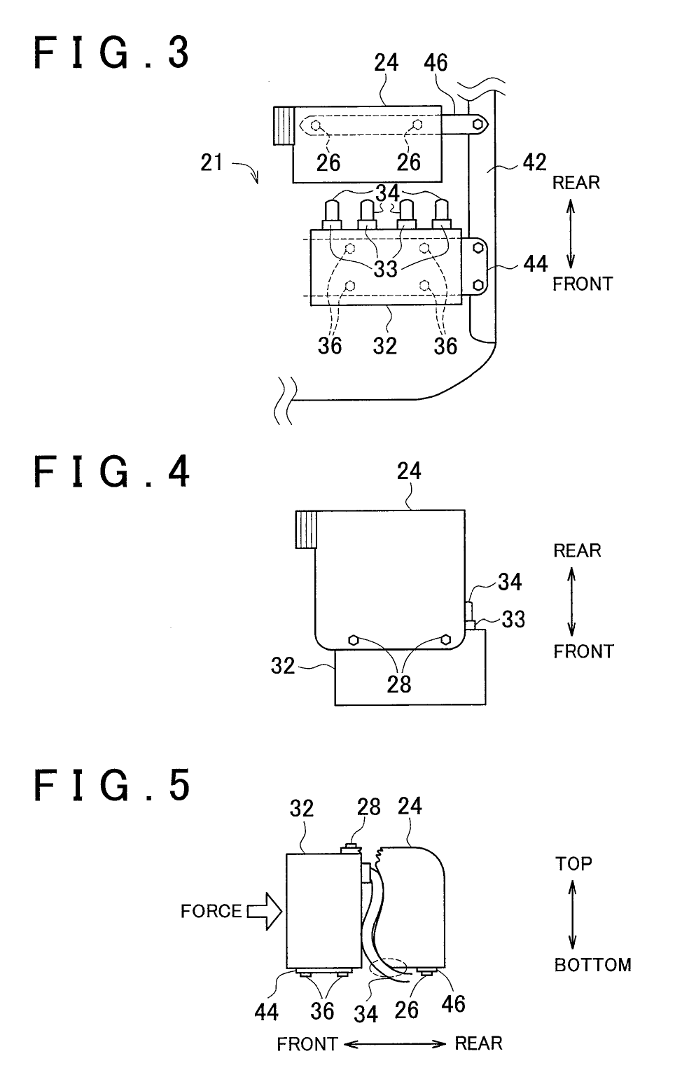

FIGS. 3 and 4 show the inverter device 32 and the air cleaner 24 in FIG. 2 as viewed from a III-III face and a IV-IV face respectively. In FIG. 3, the manner in which a member mounted to a lower portion of the inverter device 32 and a member mounted to a lower portion of the air cleaner 24 are fixed to a vehicle body is also indicated by dotted lines and solid lines. As shown in FIGS. 2 and 3, a retention member 44 as a bracket (e.g., a metal bracket or the like) fixed to a side member 42 forming part of the engine room 21 as the vehicle body by bolts is fixed to the lower portion of the inverter device 32 by a plurality of bolts 36. Thus, the inverter device 32 is retained by the retention member 44 fixed to the engine room 21. Further, a support member 46 as a bracket (e.g., a metal bracket or the like) fixed to the side member 42 by bolts is fixed to a rear lower region of the air cleaner 24 by a plurality of bolts 26. In addition, as shown in FIGS. 2 and 4, part of the resin case forming a front upper region of the air cleaner 24 is so formed as to extend to a rear upper region of the inverter device 32. The thus extending front upper region of the air cleaner 24 is fixed to the rear upper region of the inverter device 32 by bolts 28. Thus, the air cleaner 24 is supported by the inverter device 32 and the support member 46 fixed to the engine room 21.

Now, a case of a collision (especially a head-on collision) of the vehicle will be considered. FIG. 5 schematically shows a state of backward movement of the inverter device 32 and the air cleaner 24 in this case as viewed from the left side of the vehicle. In the event of the collision of the vehicle, the inverter device 32 moves backward due to the collision and is pressed against the power cable 34 rising behind the inverter device 32. Upon receiving a force, the power cable 34 moves backward and comes into contact with the resin case of the air cleaner 24. At this moment, the air cleaner 24 disposed behind the inverter device 32 is mounted in two regions different from the front lower region thereof indicated by dotted lines in FIG. 5, namely, the rear lower region thereof and the front upper region thereof to the inverter device 32 (to the side member 42 via the inverter device 32) with the aid of the support member 46, the bolts 26, and the bolts 28. Therefore, in the front lower region of the air cleaner 24, the power cable 34 can be restrained from receiving a force from the brackets or the like. As a result, in the event of the collision of the vehicle, the power cable 34 connected to the inverter device 32 can be restrained from being deformed or damaged. Further, in the embodiment of the invention, the air cleaner 24 is accommodated in the resin case. Therefore, when the power cable 34 is pressed against this air cleaner 24 due to the collision of the vehicle, the force received by the power cable 34 can be made smaller than in the case where the power cable 34 is pressed against a metal instrument or the like. As a result, the power cable 34 can be restrained from being deformed or damaged.

According to the hybrid vehicle 20 to which the mounting structure according to the embodiment of the invention is applied as described above, in the engine room 21 accommodating the engine 22 and the motor MG, the air cleaner 24 accommodated in the resin case is disposed behind the inverter device 32, which has the inverter circuit for driving the motor MG and has the connection portion 33 to which the power cable 34 rising on the rear side of the vehicle is connected, with respect to the vehicle. The air cleaner 24 is mounted in the regions different from the front lower region thereof (the rear lower region thereof and the front upper region thereof) to the engine room 21. Therefore, in the event of a collision of the vehicle, the power cable 34 can be restrained from being deformed or damaged.

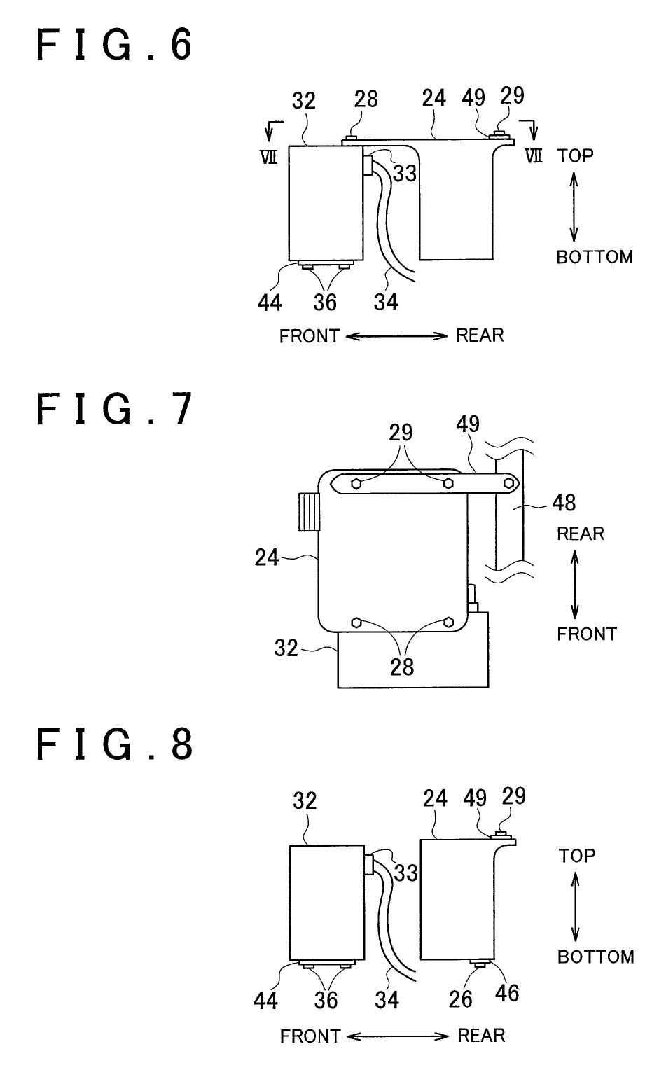

In the hybrid vehicle 20 to which the mounting structure according to the embodiment of the invention is applied, the air cleaner 24 is mounted in the front upper region thereof and the rear lower region thereof to the inverter device 32 and the side member 42. However, it is appropriate to mount the air cleaner 24 in the region different from the front lower region thereof to the engine room 21 or the member fixed to the engine room 21. Therefore, as shown in FIG. 6 and FIG. 7 (the view from the VII-VII face in FIG. 6), the air cleaner 24 may be mounted in the rear upper region thereof to a side member 48 forming part of the engine room 21 as the vehicle body with the aid of a support member 49 as a bracket (e.g., a metal bracket or the like) fixed to the side member 48 by bolts and a plurality of bolts 29, instead of being mounted in the rear lower region thereof to the side member 42 by the support member 46.

In the hybrid vehicle 20 to which the mounting structure according to the embodiment of the invention is applied, the front upper region of the air cleaner 24 is so formed as to extend to the rear upper region of the inverter device 32. This extending front upper region of the air cleaner 24 is mounted to the rear upper region of the inverter device 32. However, the front upper region of the air cleaner 24 may be so formed as not to extend. In this case, the air cleaner 24 may be fixed in the front upper region thereof to the bracket fixed to the engine room 21. Alternatively, as shown in FIG. 8, the air cleaner 24 may be mounted in the rear upper region thereof to the side member 48 with the aid of the support member 49 fixed to the side member 48 and the plurality of the bolts 29, instead of being mounted in the front upper region thereof.

In the hybrid vehicle 20 to which the mounting structure according to the embodiment of the invention is applied, the air cleaner 24 is mounted in the front upper region thereof and the rear lower region thereof to the inverter device 32 and the side member 42. However, the air cleaner 24 may be mounted in at least one of the front upper region thereof, the rear upper region thereof, and the rear lower region thereof to the engine room 21 or the member fixed to the engine room 21. Thus, the air cleaner 24 may be mounted only in the front upper region thereof, only in the rear upper region thereof, or only in the rear lower region thereof to the engine room 21 or the member fixed to the engine room 21. Further, it is also acceptable to mount the air cleaner 24 in three regions thereof, namely, in the front upper region thereof, the rear upper region thereof, and the rear lower region thereof to the engine room 21 or the member fixed to the engine room 21.

In the hybrid vehicle 20 to which the mounting structure according to the embodiment of the invention is applied, the air cleaner 24 required for the engine 22 is disposed and mounted behind the inverter device 32. However, a resin reservoir tank for storing coolant required for one or both of the engine 22 and the motor MG or the like may be disposed and mounted.

In the hybrid vehicle 20 to which the mounting structure according to the embodiment of the invention is applied, the inverter device 32 has on the rear face thereof the connection portion 33 to which the power cable 34 is so connected as to rise upward from the lower space behind the inverter device 32. The air cleaner 24 disposed behind the inverter device 32 is mounted in the regions different from the front lower region thereof (i.e., the rear lower region thereof and the front upper region thereof) to the engine room 21. However, in the mounting structure in which the power cable 34 is connected to the inverter device 32 through the upper portion of the air cleaner 24 from a region behind the vehicle, the air cleaner 24 may be mounted in a region different from the front upper region thereof (i.e., at least one of the rear upper region thereof, the front lower region thereof, and the rear lower region thereof) to the engine room 21. Further, in the mounting structure in which the power cable 34 is connected to the inverter device 32 through a left lateral portion (or a right lateral portion) of the air cleaner 24 from behind the vehicle, the air cleaner 24 may be mounted in a region different from a front region of the left lateral portion (or the right lateral portion) (i.e., at least one of a rear region of the left lateral portion (or the right lateral portion), a front region of the right lateral portion (or the left lateral portion), and a rear region of the right lateral portion (or the left lateral portion)) to the engine room 21.

In the embodiment of the invention, the case where the invention is applied to the hybrid vehicle 20 equipped with the engine 22 and the motor MG has been described. However, the invention may be applied to an electric vehicle that is not equipped with the engine 22 but with the motor MG for outputting motive power for running. In this case, instead of the air cleaner 24, a resin reservoir tank for storing coolant for cooling the motor MG and the inverter device 32 and the like may be disposed and mounted. In the embodiment of the invention, the motor MG can be regarded as “the electric motor”. The engine room 21 can be regarded as “the accommodation portion”.

The inverter device 32 can be regarded as “the inverter device”. The power cable 34 can be regarded as “the electric power cable”. The air cleaner 24 can be regarded as “the resin component”. The retention member 44 such as the metal bracket or the like and the bolts 36 can each be regarded as “the inverter mounting bracket”. The support member 46 such as the metal bracket or the like, the bolts 26, and the bolts 28 can each be regarded as “the component mounting bracket”. Further, the engine 22 can be regarded as “the internal combustion engine”. The support member 49 and the bolts 29 can each be regarded as “the component mounting bracket” as well. It should be noted herein that “the electric motor” is not limited to the motor MG constructed as the synchronous generator motor, but may be any type of electric motor such as an inductor motor or the like. “The accommodation portion” is not limited to the engine room 21 in the front portion of the vehicle, but may be any type of accommodation portion accommodating the electric motor for outputting motive power for running. “The inverter device” is not limited to the inverter device 32, but may be any type of inverter device having an inverter for driving an electric motor and mounted with an electric power cable that rises upward from a lower space behind the inverter with respect to the vehicle and leads to the inverter, such as an inverter device having a converter for making a conversion from one of high-voltage electric power and low-voltage electric power to the other. “The electric power cable” is not limited to the power cable 34, but may include a cable for connecting a low-voltage battery to a converter for making a conversion from one of high-voltage electric power and low-voltage electric power to the other. “The resin component” is not limited to the air cleaner 24, but may be a resin reservoir tank for storing coolant or the like. “The inverter mounting bracket” is not limited to each of the retention member 44 and the bolts 36, but may be any type of mounting bracket used to mount the inverter device to the accommodation portion or the member mounted to the accommodation portion. “The component mounting bracket” is not limited to each of the support member 46, the bolts 26, the bolts 28, the support member 49, and the bolts 29, but may be any type of mounting bracket used to mount the resin component to the accommodation portion or the member mounted to the accommodation portion. “The internal combustion engine” is not limited to the internal combustion engine that outputs motive power through the use of hydrocarbon fuel such as gasoline, light oil, or the like, but may be any type of internal combustion engine such as a hydrogen engine or the like.

While the invention has been described with reference to what is considered to be the preferred embodiment thereof, it is to be understood that the invention is not limited to the disclosed embodiment or construction. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

The invention is available to an automotive manufacturing industry and the like.

What is claimed is:

1. Amounting structure comprising:
an inverter device that has an inverter for driving an electric motor for outputting motive power for running a vehicle and is mounted with an electric power cable rising upward from a lower region behind the inverter with respect to the vehicle to lead to the inverter in an accommodation portion accommodating the electric motor in the vehicle;
a resin component disposed behind the inverter device with respect to the vehicle and mounted to the accommodation portion;
an inverter mounting bracket for mounting the inverter device to the accommodation portion or a member mounted to the accommodation portion; and
a component mounting bracket for mounting the resin component in at least one of a front upper region thereof, a rear upper region thereof, and a rear lower region thereof to the accommodation portion, a member mounted to the accommodation portion or the inverter device.

2. The mounting structure according to claim 1, wherein
the resin component is mounted in two of the front upper region thereof, the rear upper region thereof, and the rear lower region thereof to the accommodation portion or the member mounted to the accommodation portion with a first mounting bracket and a second mounting bracket as the component mounting bracket.

3. The mounting structure according to claim 2, wherein
the resin component is formed such that the front upper region thereof extends to a rear upper region of the inverter device, and the front upper region of the resin component is mounted to the rear upper region of the inverter device with the first mounting bracket.

4. The mounting structure according to claim 1, wherein
the resin component is an on-vehicle instrument required for an internal combustion engine installed in the vehicle and accommodated in the accommodation portion.

5. The mounting structure according to claim 1, wherein
the resin component is an on-vehicle instrument required for the electric motor, which is installed in the vehicle and accommodated in the accommodation portion.

6. The mounting structure according to claim 4, wherein
the resin component is an air cleaner.

7. A mounting structure comprising:
a secondary battery;
an inverter device that has an inverter for driving an electric motor for outputting motive power for running a vehicle in an accommodation portion accommodating the electric motor in the vehicle and is mounted with an electric power cable leading to the inverter from the secondary battery;
a resin component disposed behind the inverter device with respect to the vehicle and mounted to the accommodation portion;
a component mounting bracket for mounting the resin component to the accommodation portion, a member mounted to the accommodation portion or the inverter device,
wherein a portion of electric power cable is provided between the inverter device and the resin component, and
the component mounting bracket is not provided between the inverter device and the electric power cable or between the electric power cable and the resin component.

8. The mounting structure according to claim 7, wherein
the secondary battery is provided in a rear region of the vehicle.

9. The mounting structure according to claim 8, wherein
the electric power cable is mounted to the inverter device through an upper portion of the resin component, and
the resin component is mounted to the accommodation portion, the member mounted to the accommodation portion or the inverter device at least one of a rear upper region of the resin component, a front lower region of the resin component, and a rear lower region of the resin component.

10. The mounting structure according to claim 8, wherein
the electric power cable is mounted to the inverter device through a lower portion of the resin component, and
the resin component is mounted to the accommodation portion, the member mounted to the accommodation portion or the inverter device at least one of a front upper region of the resin component, a rear upper region of the resin component, and a rear lower region of the resin component.
